(19) United States
(12) Patent Application Publication
(10) Pub. No.: US 2026/0030245 A1
(43) Pub. Date: Jan. 29, 2026

(54) METHOD AND APPARATUS FOR COMPRESSING DATA

(71) Applicant: SAMSUNG ELECTRONICS CO., LTD., SUWON-SI (KR)

(72) Inventors: Arnab ROY, Bengaluru (IN); Nilay Nitin BIRMOLE, Bengaluru (IN); Nihar Venkata Raj BURADA, Bengaluru (IN); Jihoon NAM, Suwon-si (KR); Kiran Kolar CHANDRASEKHARAN, Bengaluru (IN); Madhur JUNEJA, Bengaluru (IN); Wooram YANG, Suwon-si (KR)

(21) Appl. No.: 19/269,243

(22) Filed: Jul. 15, 2025

(30) Foreign Application Priority Data
Jul. 25, 2024 (IN) 202441056601
Nov. 4, 2024 (KR) 10-2024-0154731

(51) Int. Cl. G06F 16/2455

(52) U.S. Cl. CPC G06F 16/24561

(57) ABSTRACT

Provided is a method and apparatus for compressing data. The method according to an embodiment includes receiving a data input string comprising one or more segments, performing a search operation on the data input string, determining a type of the search operation, wherein the type of the search operation comprises a near search operation or a far search operation, and generating one or more compressed data blocks corresponding to the one or more segments of the data input string, based on the determined type of the search operation.

### CROSS-REFERENCE TO RELATED APPLICATIONS

This application is based on and claims priority under 35 USC § 119(a) of Indian Patent Application No. 202441056601 filed on Jul. 25, 2024, in the Indian Patent Office, and Korean Patent Application No. 10-2024-0154731 filed on Nov. 4, 2024, in the Korean Intellectual Property Office, the entire contents of which are incorporated by reference herein for their entirety.

### BACKGROUND

### 1. Field of the Invention

The present disclosure describes systems and methods for compressing data.

### 2. Description of the Related Art

Modern high-performance computing systems may demand high memory capacity and bandwidth, with a significant focus on computational efficiency, due to the exponential growth in data generation. Efficient data compression techniques may be commonly employed to alleviate the capacity and bandwidth pressure on memory. In some cases, data compression reduces the size of digital information, providing for faster transmission over networks, reduced storage requirements, and enhanced computational efficiency.

Existing data compression techniques may strive to balance compression ratio (a ratio between the original data/file size and the compressed data/file size) with compression/decompression speed. Various algorithms, such as algorithms in the Lempel-Ziv family, have been developed to achieve lossless data compression, where the original data can be completely reconstructed from the compressed data. Such algorithms are widely used in applications ranging from file storage to real-time data streaming.

However, despite advancements, existing data compression techniques face limitations when balancing compression ratio, processing speed, and computational resource usage. In some cases, high-compression algorithms are computationally intensive, making such algorithms unsuitable for resource-constrained environments, while fast algorithms often sacrifice compression efficiency. Therefore, there is a need in the art for systems and methods that provide optimal data compression performance.

The above description has been possessed or acquired by the inventor(s) in the course of conceiving the present disclosure and is not necessarily publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure describes systems and methods for data compression. Embodiments of the present disclosure are configured to determine a type of search operation on an input data string. In some cases, a compressed data block is generated based on the determined search operation type. For example, the compressed data block is generated corresponding to one or more segments of the input data string. In some examples, the type of the search operation comprises at least one of a near search operation associated with a near buffer and a far search operation associated with a far buffer.

A data compression method according to an embodiment may include receiving a data input string comprising one or more segments, performing a search operation on the data input string, determining a type of the search operation, wherein the type of the search operation comprises a near search operation or a far search operation, and generating one or more compressed data blocks corresponding to the one or more segments of the data input string based on the determined type of the search operation.

The generating may include, in response to the type of search operation being determined as the near search operation, including an indication of the near search operation in the one or more compressed data blocks.

Each of the one or more first segments may have a minimum size of 3 bytes and the one or more first compressed data blocks may have a minimum size of 2 bytes based on the type of the search operation comprising the near search operation.

The generating may include, in response to the type of search operation being determined as the far search operation, including an indication of the far search operation in the one or more compressed data blocks.

Each of the one or more second segments may have a minimum size of 4 bytes and the one or more second compressed data blocks may have a minimum size of 3 bytes based on the type of the search operation comprising the far search operation.

The method may further include indicating the determined type of the search operation in at least one bit of a token field of each of the one or more compressed data blocks.

The method may further include indicating a block among the one or more compressed data blocks as a last compressed block using an unused bit of the one or more compressed data blocks.

A non-transitory computer-readable storage medium storing instructions that, when executed by a processor, cause the processor to perform operations including: receiving a data input string comprising one or more segments; performing a search operation on the data input string; determining a type of the search operation, wherein the type of the search operation comprises a near search operation or a far search operation; and generating one or more compressed data blocks corresponding to the one or more segments of the data input string based on the determined type of the search operation.

The non-transitory computer readable medium, wherein each of the one or more segments has a minimum size of 3 bytes and the one or more compressed data blocks has a minimum size of 2 bytes based on the type of the search operation comprising the near search operation.

The non-transitory computer readable medium, wherein each of the one or more segments has a minimum size of 4 bytes and the one or more compressed data blocks has a minimum size of 3 bytes based on the type of the search operation comprising the far search operation.

The non-transitory computer readable medium, wherein the generating comprises indicating the determined type of the search operation in at least one bit of a token field of each of the one or more compressed data blocks.

The non-transitory computer readable medium, wherein the generating comprises indicating a block among the one or more compressed data blocks as a last compressed block using an unused bit of the one or more compressed data blocks.

An electronic device according to an embodiment may include one or more processors, and a memory configured to store instructions. The instructions, when executed by the one or more processors, may cause the device to receive a data input string comprising one or more segments, perform a search operation on the data input string, determine a type of the search operation, wherein the type of the search operation comprises a near search operation or a far search operation, and generate one or more compressed data blocks corresponding to the one or more segments of the data input string based on the determined type of the search operation.

The instructions, when executed by the one or more processors, may cause the device to, in response to the type of search operation being determined as the near search operation, include an indication of the near search operation in the one or more compressed data blocks.

Each of the one or more first segments may have a minimum size of 3 bytes and each of the one or more first compressed data blocks may have a minimum size of 2 bytes based on the type of the search operation comprising the near search operation.

The instructions, when executed by the one or more processors, may cause the device to, in response to the type of search operation being determined as the far search operation, include an indication of the far search operation in the one or more compressed data blocks.

Each of the one or more second segments may have a minimum size of 4 bytes and each of the one or more second compressed data blocks may have a minimum size of 3 bytes based on the type of the search operation comprising the far search operation.

The instructions, when executed by the one or more processors, may cause the device to indicate the determined type of the search operation in at least one bit of a token field of each of the one or more compressed data blocks.

The instructions, when executed by the one or more processors, may cause the device to indicate a block among the one or more compressed data blocks as a last compressed block using an unused bit of the one or more compressed data blocks.

Other features and aspects will be apparent from the following detailed description, the drawings, and the claims.

### BRIEF DESCRIPTION OF THE DRAWINGS

These and other aspects, features, and advantages of the present disclosure will become apparent and more readily appreciated from the following description of embodiments, taken in conjunction with the accompanying drawings of which:

FIGS. 1A and 1B illustrate history-based compression techniques;

FIG. 2A is a block diagram illustrating a system for performing a search-based compression technique, and FIG. 2B is a flowchart illustrating a search-based compression technique;

FIGS. 3A to 3C illustrate the structure of Lempel-ziv 4 (LZ4) compression blockchains;

FIG. 4 is a block diagram illustrating a system for optimized data compression using a history-based compression technique, in accordance with an embodiment of the present disclosure;

FIG. 5 is a flowchart illustrating an optimized data compression method, in accordance with an embodiment of the present disclosure;

FIG. 6 illustrates a minimum block when the data compression method is used, in accordance with an embodiment of the present disclosure, and FIG. 7 illustrates the size of a match offset according to a type of search operation, in accordance with an embodiment of the present disclosure;

FIG. 8 illustrates a last compressed block, in accordance with an embodiment of the present disclosure;

FIGS. 9A and 9B illustrate exemplary scenarios of determining an unused bit to indicate the last compressed block, in accordance with an embodiment of the present disclosure;

FIGS. 10A to 13B illustrate various exemplary scenarios of the enabled states of a near buffer and a far buffer, in accordance with an embodiment of the present disclosure; and

FIG. 14 is a block diagram illustrating an example of an electronic device, in accordance with an embodiment of the present disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following structural or functional descriptions of embodiments are merely intended for the purpose of describing the embodiments and the embodiments may be implemented in various forms. The embodiments are not meant to be limited, but it is intended that various modifications, equivalents, and alternatives are also covered within the scope of the claims.

The present disclosure describes systems and methods for data compression. Embodiments include a data compression process that is based on a search operation type (e.g., a near search operation or a far search operation). By indicating the search operation type, embodiments improve the flexibility and efficiency of the data compression.

Some embodiments of the present disclosure are configured to determine a type of search operation on an input data string. In some cases, a compressed data block is generated based on the determined search operation type. For example, the compressed data block is generated corresponding to one or more segments of the input data string. In some examples, the type of the search operation comprises at least one of a near search operation associated with a near buffer and a far search operation associated with a far buffer.

Existing data compression techniques are often tailored for specific use cases, resulting in trade-offs between compression ratio and processing speed. For example, an algorithm designed for high-speed data streaming may not provide sufficient compression for storage-intensive applications, leading to inefficiencies in data handling. Furthermore, in some cases, a compression method may require substantial memory including overheads and computational power, limiting the applicability in devices with constrained resources, such as embedded systems or mobile devices.

Additionally, a challenge for existing data compression techniques is the lack of flexibility in adapting to diverse data types and structures. Existing algorithms may struggle to achieve consistent performance across datasets with varying characteristics, such as text, images, or numerical data. Such limitations hinder the scalability and adaptability of existing compression solutions, underscoring the need for a method and apparatus that address these shortcomings while delivering high performance.

Accordingly, the present disclosure relates to a method and apparatus for compressing data that addresses the shortcomings of existing techniques by providing a flexible, efficient, and scalable solution. Embodiments of the present disclosure are configured to achieve a high compression ratio while maintaining fast processing speeds, making it suitable for a wide range of applications, including file storage, real-time communication, and embedded systems. By leveraging an optimized approach to encoding and data structure management, embodiments of the present disclosure significantly improve the efficiency of data handling processes.

The present disclosure describes systems and methods for data compression. Embodiments of the present disclosure are configured to perform an optimized history-based compression, e.g., Lempel-ziv 4 (LZ4) compression, on a series of blocks of a blockchain to generate a compressed block. In some examples, the compressed data block comprises strings with a repeated pattern.

In some cases, the compressed block includes a token section, a literal section, and a match section. In some cases, the token section includes information related to the literal section and the match section. In some cases, the match section includes a length information and raw data. In some cases, the match section includes an offset that is used to indicate a match position. For example, the match position includes information related to the maximum input string size and a threshold length of a match.

In some cases, a last compressed block in a series of blocks omits a match section. For example, by omitting the match section, embodiments of the present disclosure reduce the overhead of the last compressed block. In some examples, when performing a scan of an input string, embodiments ensure the pattern ends with a mismatch to prevent an occurrence of a match offset byte. In some cases, embodiments of the present disclosure use a last block (LB) flag which helps identify the last block and comprises an unused bit of the compressed block.

According to an embodiment, a size of a match offset may be reduced to obtain the unused bit for the LB flag. For example, a near buffer may include a maximum size of 256 bytes. In some examples, the size of the near buffer is reduced from 256 bytes to 128 bytes which results in a reduction of the size of the match offset. Accordingly, the unused bits for incorporation of the LB flag may be obtained.

An exemplary embodiment of the present disclosure is configured to select a configuration for compression of an input string. For example, the input string may be compressed based on a size of the near buffer. Additionally, for example, the input string may be compressed based on an enabled or a disabled far buffer. In some examples, the size of the match offset may be determined based on the configuration.

Therefore, by performing data compression based on the type of search operation such as the near search operation or the far search operation, embodiments of the present disclosure area able to reduce an overhead associated with the match offset byte. Additionally, by indicating the last compressed block in the chain of compressed data blocks using the LB flag in unused bits, embodiments of the present disclosure optimize the history-based compression (e.g., LZ4 compression) based on reducing the overhead of indicating the last compressed data block. In some cases, embodiments improve the compression ratio based on a reduction in the match offset.

Embodiments of the present disclosure are configured to perform a data compression for a data input string comprising a plurality of segments. In some cases, a compressor performs a search operation on the data input string. For instance, the search operation is performed based on a type of search operation including a near search operation and a far search operation. In some examples, the compressed data block is generated based on the type of search operation determined by the compressor.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

It will be understood that when a component is referred to as being “connected to” another component, the component can be directly connected or coupled to the other component or intervening components may be present.

As used herein, the singular forms “a,” “an,” and “the” are intended to include the plural forms as well, unless the context clearly indicates otherwise. As used herein, the terms “and/or,” “at least one of A and B,” “at least one of A or B,” “A, B or C,” “at least one of A, B and C,” and “at least one of A, B or C” include any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

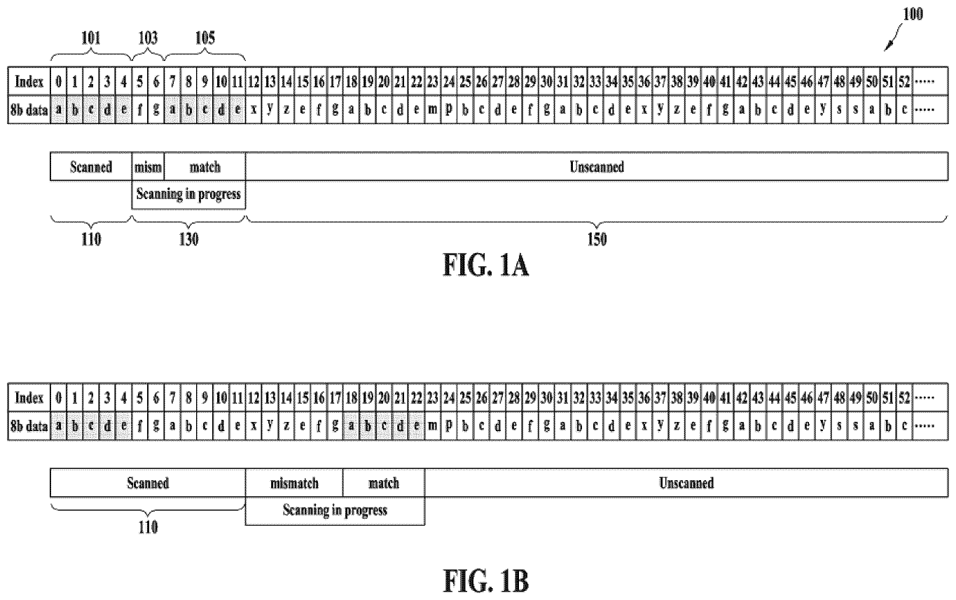

FIG. 1A and FIG. 1B illustrate history-based compression techniques.

Referring to FIGS. 1A and 1B, a string 100 may be composed of 8-bit characters. The string 100 may include n regions (e.g., three regions) such as a scanned region 110, a scanning in progress region 130, and an unscanned region 150. The scanned region 110 may also be known as history. In some cases, a pattern may be obtained based on the history. For example, while scanning data, a possible pattern such as “abcde” (indicated in 101) may be found in the scanned region 110. Hence, in some examples, “abcde” may be referred to as a matched pattern or a matched string. The matched string, i.e., pattern 101, may be found at position 0 with a size of 5 bits. Accordingly, the matched information may be encoded using a tuple (e.g., {loc=0, size=5}) (i.e., instead of copying “abcde” again) and stored as compressed data. In some cases (e.g., programming), a tuple may refer to a data structure representing a collection of values including an order. In some cases, a pattern 105 comprising the same pattern (e.g., a matched pattern) as pattern 101 may be discovered during data scanning. The remaining data (e.g., pattern 103 such as “fg”) that is before the matched pattern (e.g., pattern 105) may be considered as a mismatched string. In some cases, the mismatched string (e.g., pattern 103) may be copied (e.g., copied as such) to the compressed data (e.g., “fg” in FIG. 1A). The data that are not scanned may be referred to as the unscanned region 150. Subsequently, i.e., after processing (e.g., storing the corresponding information in the compressed data) the matched pattern and the mismatched string, the scanning in progress region 130 may be included in the scanned region 110. For example, as shown in FIG. 1B, the scanning in progress region 130 of FIG. 1A may be included in the scanned region 110 such that the scanned region 110 may be extended to the character at 11.

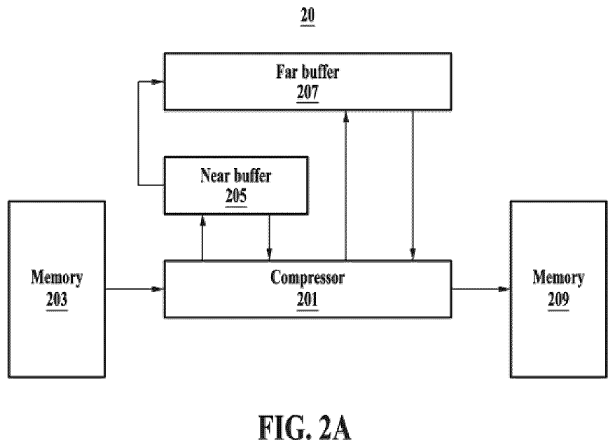

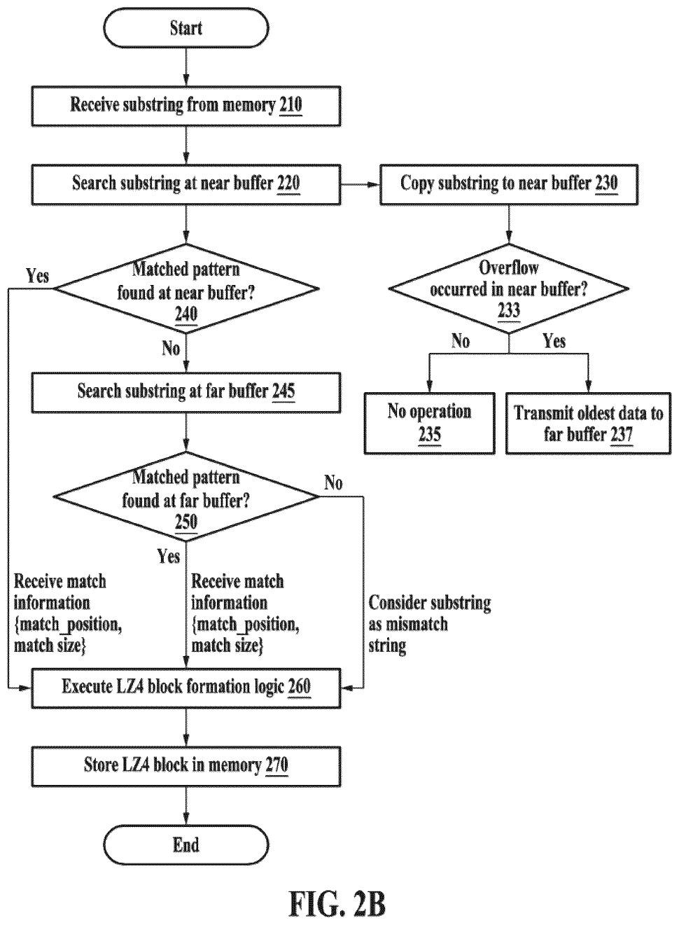

FIG. 2A is a block diagram that illustrates a system for performing a search-based compression technique. FIG. 2B is a flowchart illustrating a search-based compression technique.

Referring to FIG. 2A, a system 20 may include a compressor 201, a memory 203, a near buffer 205, a far buffer 207, and a memory 209. In some cases, the memory 203 may store the original data to be compressed. The memory 209 may store compressed data obtained from the compressor 201. The compressor 201 may include a history-based compressor such as Lempel-ziv 4 (LZ4) compressor. LZ4 compression logic may be executed inside the LZ4 compressor 201 to compress data.

As used herein, the LZ4 compressor refers to a data compression algorithm that implements a variant of the Lempel-Ziv compression family. The LZ4 compressor is designed to achieve fast compression and decompression speeds while maintaining a moderate compression ratio. LZ4 operates by identifying repeated sequences of data within an input stream and encoding the sequences as references to previous occurrences, thereby reducing redundancy.

The algorithm uses a sliding window technique, where it examines a limited portion of the input data to locate matching substrings. On finding a match, LZ4 encodes the match as a pointer to the position of the substring within the window, combined with the match length. Unmatched data is stored as literals, ensuring lossless compression.

In some examples, the history-based (e.g., LZ4) compressor is not complicated and optimized for speed. The compressor employs a fixed-length encoding format that minimizes computational overhead, enabling real-time processing. By leveraging the principles of compression and efficient encoding, LZ4 achieves a balance between compression ratio and speed, making the compressor an effective solution for data-handling applications.

The history (e.g., the scanned region 110 in FIGS. 1A and 1B) may be maintained using two buffers, for example, the near buffer 205 and the far buffer 207. The near buffer 205 may have a lower size than the far buffer 207 or a lower capacity than the far buffer 207. In some cases, the near buffer 205 may be accessed faster than the far buffer 207. Accordingly, a search may be performed at the near buffer 205 first, followed by the far buffer 207 to find a match (e.g., a matched pattern). The two buffers, for example, the near buffer 205 and the far buffer 207, may store data in an order of the youngest to oldest sequence in a shift manner.

Referring to FIG. 2B, operations 210 to 270 may be operations performed by components of the system 20.

As shown in FIG. 2B, in operation 210, the compressor 201 may receive a substring from the memory 203, wherein the substring is a portion of the original data (e.g., original string) to be compressed.

In operation 220, the compressor 201 may evaluate whether the substring received in operation 210 is available in the near buffer 205. The compressor 201 may transmit the received substring to the near buffer 205 to check whether the substring is available in the near buffer 205.

In operation 230, the near buffer 205 may copy the substring received from the compressor 201.

In operation 233, occurrence of an overflow in the near buffer 205 is determined. In response to an overflow occurring in the near buffer 205, operation 237 may be performed. In case there is no overflow in the near buffer 205, operation 235 may be performed.

In operation 235, the near buffer 205 may not perform any further operations.

In operation 237, the oldest data (e.g., oldest data in the sequential order) may be transmitted from the near buffer 205 to the far buffer 207.

In operation 240, the compressor 201 may determine whether a matched pattern is available (e.g., a search result) in the near buffer 205. For example, the compressor 201 may determine whether a string having a pattern matched with the substring is available in the near buffer 205 based on the search result. In case a string having a matched pattern with the substring is available in the near buffer 205, the compressor 201 may perform operation 260. In response to receiving matched information from the near buffer 205, the compressor 201 may determine that a matched pattern with the substring is available in the near buffer 205. In some cases, the matched information may include information on a match position and a match size.

In response to determining that a matched pattern with the substring is not available in the near buffer 205, the compressor 201 may perform operation 245. Thus, in case of no match, the compressor 201 may determine that a matched pattern with the substring is not available in the near buffer 205. In response to a string having a matched pattern with the substring (e.g., in response to receiving matched information) in the near buffer 205, the compressor 201 may not perform a search for the far buffer 207.

In operation 245, the compressor 201 may search the substring at the far buffer 207.

In operation 250, the compressor 201 may determine whether a matched pattern is available in the far buffer 207. For example, the compressor 201 may determine whether a string having a matched pattern with the substring is available in the far buffer 207 based on the search result obtained in operation 245. In response to determining that a string having a matched pattern with the substring is available in the far buffer 207, the compressor 201 may perform operation 260. Thus, operation 260 is performed based on the determination that a matched pattern with the substring is available in the far buffer 207. The matched information may include information on a match position and a match size. In response to determining that a matched pattern with the substring is not available in the far buffer 207, the compressor 201 may consider the substring to be a mismatched string and directly perform operation 260 (operation 250: No). That is, in response to receiving from the far buffer 207 that there is no match, the compressor 201 may determine that a matched pattern with the substring is not available in the far buffer 207. Therefore, in response to a string having a matched pattern with the substring being available (e.g., in response to receiving matched information) in at least one of the near buffer 205 or the far buffer 207, the compressor 201 may perform operation 260.

In operation 260, the compressor 201 may execute LZ4 block formation logic.

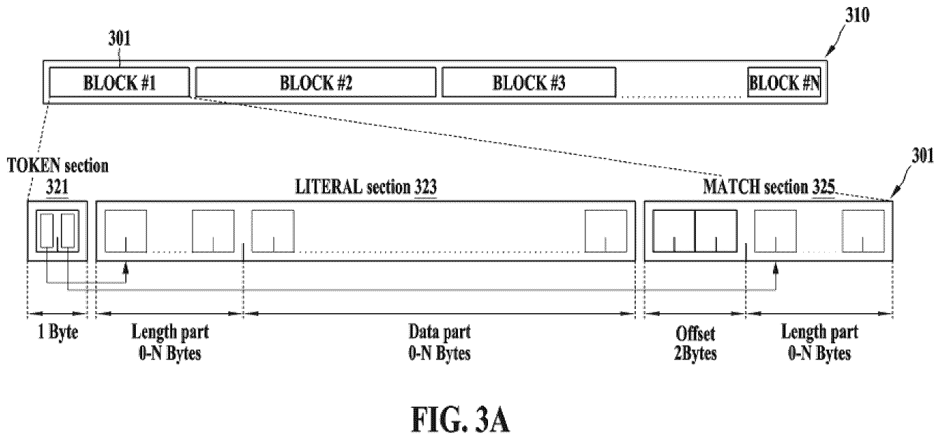

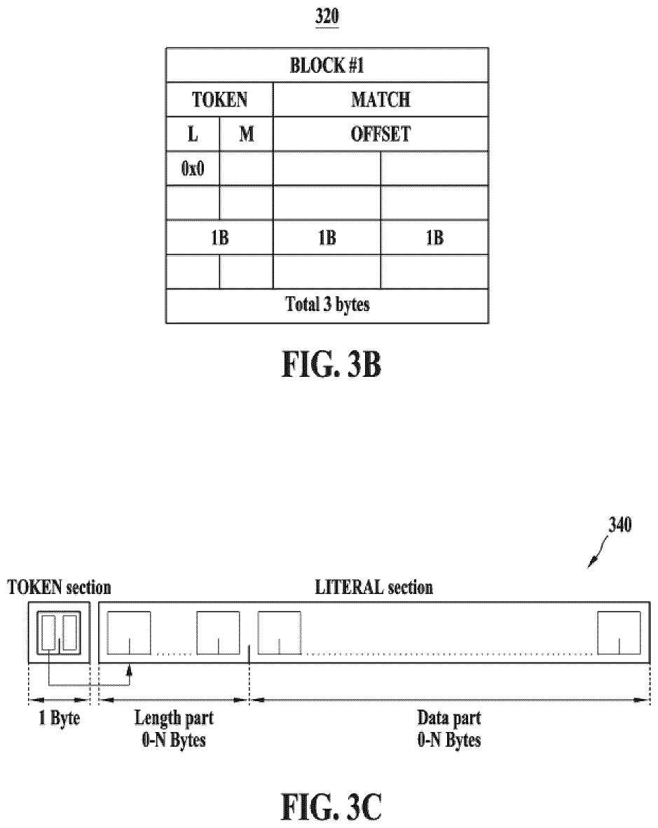

In operation 270, the compressor 201 may store an LZ4 block in the memory 209. Further details regarding the generated LZ4 block are provided with reference to FIGS. 3A to 3C.

FIGS. 3A to 3C illustrate the structure of a history-based (e.g., LZ4) compression blockchains.

Referring to FIG. 3A, a blockchain 310 may be a chain of LZ4 blocks (e.g., block #1 301, block #2 to block #N) generated based on a history-based (e.g., LZ4) compression technique, wherein the LZ4 compression technique is used to compress the original data. The organization of each block may balance out the encoding bits both for a match string (e.g., a string having a matched pattern with a substring) and a mismatch string. The LZ4 block may not have a fixed size. For example, a plurality of blocks included in the blockchain 310 may have different sizes. The LZ4 block may include information about the match string and the mismatch string.

As shown in FIG. 3A, each of the LZ4 blocks (e.g., block 301) may have a plurality of (e.g., three) sections, such as, for example, a TOKEN section 321, a LITERAL section 323, and a MATCH section 325. The TOKEN section 321 may have a size of 1 byte and may contain partial information of a literal length and a match length.

As used herein, the literal length refers to the length of the sequence of raw, uncompressed data (i.e., literals) that directly precedes a compressed match. Literals are data segments that cannot be compressed or do not have a sufficiently long match in the sliding window. In some cases, the literals are written directly to the output stream. The literal length indicates the number of bytes of such uncompressed data that may be present.

As used herein, the match length refers to the number of bytes in a sequence that is compressed as a reference to a previously occurring substring within the sliding window. In case of a repeating pattern or sequence in the data, the LZ4 algorithm encodes the repeated pattern or sequence using a pointer to its prior occurrence and the match length, which specifies the size of the referenced pattern. In case of the LZ4 algorithm, the match length may meet a minimum threshold (e.g., typically 4 bytes) to justify compression, as a short match is less efficient to encode. In some cases, the literal length and the match length may together define the segmentation and encoding of the input data into the compressed format.

For example, referring again to FIG. 3A, the upper 4 bits (e.g., [TOKEN[7:4]) of the TOKEN section 321 may represent information (e.g., [TOKEN [7:4]/TOKEN.L]) about the literal length. Additionally, the lower 4 bits (e.g., TOKEN [3:0]) may contain information (e.g., [TOKEN [3:0]/TOKEN.M]) about the match length. Total literal length (hereinafter, lit_length) may be calculated from 4 bits (e.g., TOKEN [7:4]) of the TOKEN section 321 (mandatory) and the length part of the LITERAL section 323 (optional). For example, the lit_length may be calculated by Equation 1 as follows:

$$If TOKEN [ 7 : 4 ] < 0 XF : lit\_length = TOKEN [ 7 : 4 ] ( LITERAL \cdot Length bytes are absent ) \qquad [ Equation 1 ]$$

$$Else : lit\_length = TOKEN [ 7 : 4 ] + {\sum }_{i = 0}^{N - 1} LITERAL \cdot Length [ i ]$$

In some cases, the LITERAL section 323 may be optional. In some cases, the LITERAL section may have various sizes, i.e., from 0 bytes to N bytes. The LITERAL section 323 may include a length part (e.g., LITERAL.Length) and a data part. The length part may be an additional byte part to indicate the lit_length. In some cases, the data part may be a byte part containing actual data of the LITERAL section 323. Referring to Equation 1, the length part (e.g., LITERAL. Length or lit_length) of the LITERAL section 323 may be valid only when the value of an upper bit (e.g., TOKEN [7:4] in TOKEN section 321) is 0xF. For example, when the upper bit (e.g., TOKEN [7:4]) of the TOKEN section 321 has a value of 0x0 to 0xE, the length part (e.g., LITERAL. Length) of the LITERAL section 323 may not be valid, and the value of the upper bit (e.g., TOKEN [7:4]) of the TOKEN section 321 may be used as the size of the LITERAL section 323. A last byte (e.g., LITERAL. Length [N−1]) of the length part (e.g., LITERAL. Length) of the LITERAL section 323 may not be 0xFF. After a scanning of the LITERAL. Length bytes, mismatched literals or characters corresponding to the length part of the LITERAL section 323 may be copied into the LZ4 block, for example, block 301.

The MATCH section 325 may be a mandatory section and may vary in size from 2 bytes to N bytes. The MATCH section 325 may contain an offset of 2 bytes. In some cases, the offset of 2 bytes may be used to point match positions. For example, the offset may be used to indicate that the maximum input string size is 2\hat{ }16=64 KB. The length part of the MATCH section (e.g., MATCH.Length) 325 may depend on a threshold value for the match length (e.g., the length of the MATCH section 325). For example, in some cases, the threshold value may be 4. Accordingly, the MATCH section 325 may be formed until minimum match length 4 is found. The total match length (hereinafter, match_length) may be calculated from 4 bits (e.g., TOKEN [3:0]) of the TOKEN section 321 (mandatory) and the length part of the MATCH section 325 (optional), as shown below in Equation 2:

$$If TOKEN [ 3 : 0 ] < 0 XF : match\_length = TOKEN [ 3 : 0 ] ( MATCH \cdot Length bytes are absent ) + 4 ( match threshold ) \qquad [ Equation 2 ]$$

$$Else : match\_length = TOKEN [ 3 : 0 ] + {\sum }_{i = 0}^{N - 1} MATCH \cdot Length [ i ] + 4 ( match threshold )$$

In some cases, the length part (e.g., MATCH. Length) byte of the MATCH section 325 may be valid until a non-0xFF byte is found. The last byte (e.g., MATCH.Length [N−1]) of the length part of the MATCH section 325 may not be 0xFF.

FIG. 3B illustrates a minimum block.

Referring to FIG. 3, a minimum block (e.g., block 320) size may dictate a match threshold value (e.g., a minimum number of 8-bit data or a byte or an ASCII character may be considered as a match). For example, when the minimum block size is 3 bytes (as shown in block 320 of FIG. 3B) then at least 4 bytes (4 characters) may be used to form the match string. In some examples, the 4 bytes of data may be encoded using 3 bytes and hence a positive compression (4/3=1.33 compression ratio) is obtained. As shown in FIG. 3B, the minimum block may not contain any literal (e.g., the mismatch string), because the literals are stored as it is (e.g., byte-wise) which would increase the block size. Hence, the value of TOKEN.L included in block 320 may be 0. The value of TOKEN.M may be less than 0XF, such that the block 320 may not contain an additional match length bytes.

In case of the LZ4 compression logic, the match length may be calculated relative to a match threshold value to encode a high number of bytes using the minimum block (e.g., block 320). For example, as per an existing art, the match threshold value may be 4. The match threshold value may define a minimum match length of the string to form the MATCH section 305. Accordingly, for example, when the match length is 13, the match length value may be adjusted with the match threshold value 4 (e.g., 13−4=9). Referring to FIG. 3B, TOKEN.M may be 0x9. In some cases, the existing minimum block may be sub optimized followed by another optimization.

FIG. 3C illustrates a last block.

Referring to FIG. 3C, according to a history-based compression (e.g., LZ4 compression) technique, the block organization of a LAST block (e.g., BLOCK #N of FIG. 3A or block 340) may differ (e.g., slightly differ) from the other blocks (e.g., block 301 to BLOCK #N−1). For example, block 340 may be a compressed block. For example, in case of the history-based (E.G., LZ4) compression technique, the LAST block may be used to indicate an end of the blocks. In some cases, the last block (e.g., block 340) may have a structure (as shown in FIG. 3C) different from other blocks (as shown in FIGS. 3A and 3B). As shown in FIG. 3C, the LAST block (e.g., block 340) may not contain any match information (e.g., TOKEN.M=0). Additionally, the LAST block (e.g., block 340) may not contain an offset included in the match section. In case of the LAST block (e.g., block 340), bytes after token may refer to either length information (e.g., length bytes) or mismatch string. Hence, to form the LAST block, there may be a mismatch string at the end which is encoded by the LAST block. In case of the LAST block, when the scanning of the original string ends with a matched string, for example, an unnecessary LAST block overhead of minimum 2 bytes (i.e., 1 byte TOKEN+1 byte LITERAL) may be obtained. Therefore, there is a need to develop systems and techniques for improving the history-based (e.g., LZ4) compression while reducing the unnecessary overhead.

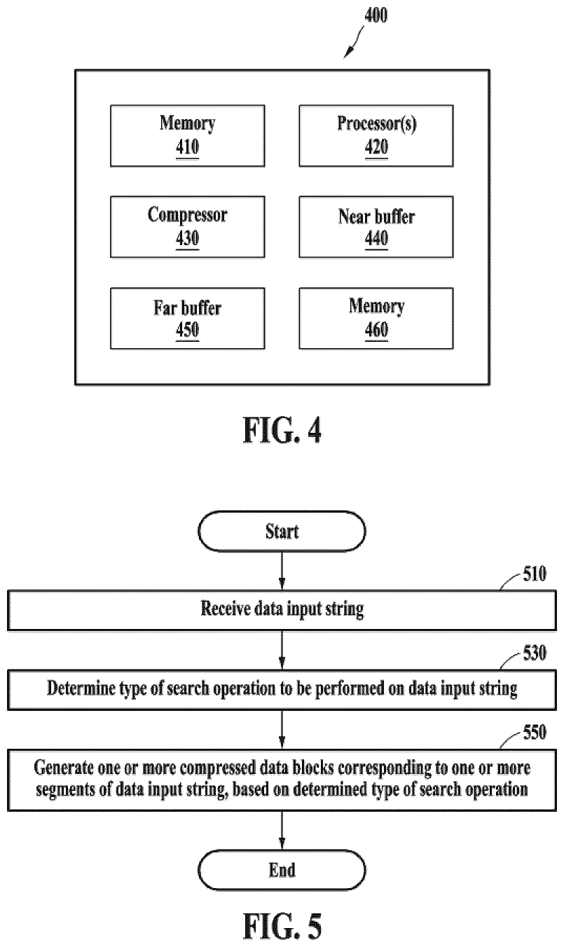

FIG. 4 is a block diagram illustrating a system for optimized data compression using the history-based (E.G., LZ4) compression technique, in accordance with an embodiment of the present disclosure.

Referring to FIG. 4, a system 400 may include, but is not limited to, a first memory 410, processor(s) 420, a compressor 430, a near buffer 440, a far buffer 450, and a second memory 460. The first memory 410, the compressor 430, the near buffer 440, the far buffer 450, and the second memory 460 may be coupled to the processor(s) 420. According to an embodiment, the system 400 may be part of an electronic device, such as a mobile device, a personal computer (PC), a laptop and similar electronic devices capable of compressing data as discussed herein.

The first memory 410 and the second memory 460 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. Further, at least one of the first memory 410 and the second memory 460 may include an operating system for performing one or more tasks of the system 400, as performed by a generic operating system in the domain of compressing data. Further, the first memory 410 may store data input strings that need to be compressed and the second memory 460 may store the compressed data blocks, as discussed herein.

The processor(s) 420 may compress the data input strings received from the first memory 410 and may generate the compressed data blocks. The processor(s) 420 may be configured to perform the compression method as described with reference to FIG. 5. The processor(s) 420 may be a single processing unit or several units, each of which could include multiple computing units. The processor(s) 420 may be implemented as one or more microprocessors, microcomputers, microcontrollers, digital signal processors, central processing units, state machines, logic circuitries, and/or any device that manipulates signals based on operational instructions. Additionally, the processor(s) 420 may be configured to fetch and execute computer-readable instructions and data stored in the first memory 410 and the second memory 460.

The compressor 430 may include a history-based (e.g., an LZ4) compressor. The compressor 430 may compress the data input strings received from the first memory 410 and generate the compressed data blocks. The compressor 430 may be configured to perform the compression method as described with reference to FIG. 5.

The near buffer 440 may have a lesser size or a lower capacity than the far buffer 450. In some cases, the near buffer 440 may be accessed faster than the far buffer 450. Additionally, the near buffer 440 may be used to perform a near search operation and the far buffer 450 may be used to perform a far search operation.

FIG. 5 is a flowchart illustrating an optimized data compression method, in accordance with an embodiment of the present disclosure. Referring to FIG. 5, operations 510 to 550 may be performed by components of the system 400 described with reference to FIG. 4.

In operation 510, a compressor (e.g., the compressor 430 of FIG. 4) may receive a data input string from a memory (e.g., the memory 410 of FIG. 4). For example, the data input string comprises a segment of data (i.e., a plurality of data segments).

In operation 530, the compressor 430 may determine a type of search operation to be performed on the data input string. The type of search operation may include at least one of a near search operation and a far search operation. The compressor 430 may determine the type of search operation to be performed based on a size of the received data input string. The compressor 430 may determine the type of search operation to be performed on the data input string based on whether a match is found at a near buffer (e.g., the near buffer 440 of FIG. 4) or a far buffer (e.g., the far buffer 450 of FIG. 4). The compressor 430 may perform the near search operation when the data input string received in operation 510 is searched at the near buffer 440. In response to no match being found at the near buffer 440, the compressor 430 may perform the far search operation in which a match for the data input string is searched for at the far buffer 450.

In operation 550, the compressor 430 may generate one or more compressed data blocks corresponding to one or more segments of the data input string, based on the determined type of search operation. In case of the near search operation, the compressor 430 may select one or more first segments of the data input string and generate one or more first compressed data blocks corresponding to the one or more first segments of the data input string. In some cases, the one or more first compressed data blocks are generated by performing the near search operation on the one or more first segments of the data input string. The compressor 430 may perform the near search operation using the near buffer 440. Each of the one or more first segments of the data input string may have a minimum value of 3 bytes. Each of the one or more first compressed data blocks may have a minimum value of 2 bytes.

Referring again to operation 530, in case of the far search operation, the compressor 430 may generate one or more second compressed data blocks corresponding to one or more second segments of the data input string by performing the far search operation on the one or more second segments of the data input string. The compressor 430 may perform the far search operation using the far buffer 450. Since the minimum block size for the far search operation is 3 bytes, a match threshold value may be 4 bytes. In some cases, a length of a string to be compressed may be at least 4 bytes. Accordingly, each of the one or more second segments of the input data string may have a minimum size of 4 bytes and each of the one or more second compressed data blocks may have a minimum size of 3 bytes.

The compression method may further include indicating a block among the one or more compressed data blocks (e.g., the first and second compressed data blocks) as a last compressed block using an unused bit of the one or more compressed data blocks.

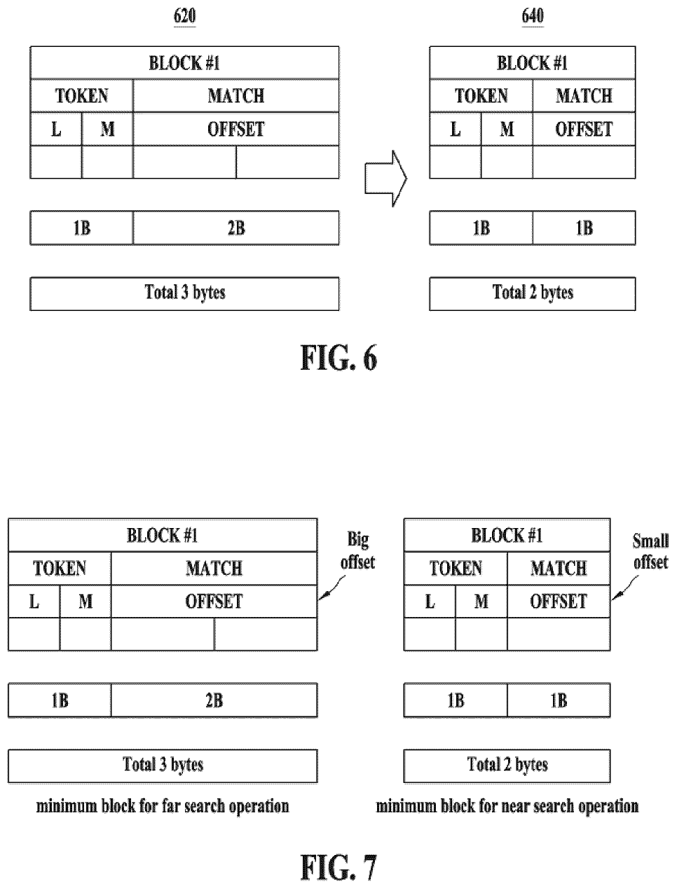

FIG. 6 illustrates a minimum block when the data compression method is used, in accordance with an embodiment of the present disclosure. FIG. 7 illustrates the size of a match offset according to a type of search operation, in accordance with an embodiment of the present disclosure.

Referring to FIG. 6, a match offset size of a minimum block (e.g., block 620) may be 2 bytes or 16 bits as described above with reference to FIG. 3A. In some cases, based on the 16 bits match offset size, the maximum search history or buffer size possible may be 2¹⁶=64 KB. In some cases, when the maximum size of a near buffer (e.g., the near buffer 440 of FIG. 4) may be 2⁸=256 bytes, then the match offset required may be 8 bits or 1 byte (i.e., instead of 16 bits or 2 bytes). Such a reduction in the match offset may enhance the compression ratio (e.g., original data size/compressed data size).

In case of a compression algorithm (e.g., an existing algorithm), the match offset size may be 2 bytes regardless of the type (e.g., the near search operation or the far search operation) of search operation. According to an embodiment of the present disclosure, the match offset size of 1 byte may be used for each of the match strings found at the near buffer 440 using the near search operation. Accordingly, the size of each of the one or more first compressed data blocks may be reduced by 1 byte, which may result in each of the one or more first compressed data blocks having a minimum size of 2 bytes, such as block 640 shown in FIG. 6. Accordingly, the size of the minimum data block for the near search operation may be reduced from 3 bytes to 2 bytes.

Additionally, in case of a compression algorithm (e.g., an existing algorithm), the match threshold value may be 4 bytes since the minimum block (e.g., block 620, block 320 of FIG. 3B) size is 3 bytes. By contrast, in accordance with an embodiment of the present disclosure, the match threshold value may be 3 bytes since the minimum block size for the near search operation is 2 bytes. Thus, the length of a string to be compressed may be at least 3 bytes. Accordingly, each of the one or more first segments of the data input string may have a minimum size of 3 bytes. In some cases, the compression ratio may be increased due to a reduction in the match threshold value.

According to an embodiment of the present disclosure, the match offset size for the near search operation may be referred to as a small offset and the match offset size for the far search operation may be referred to as a big offset, as shown in FIG. 7.

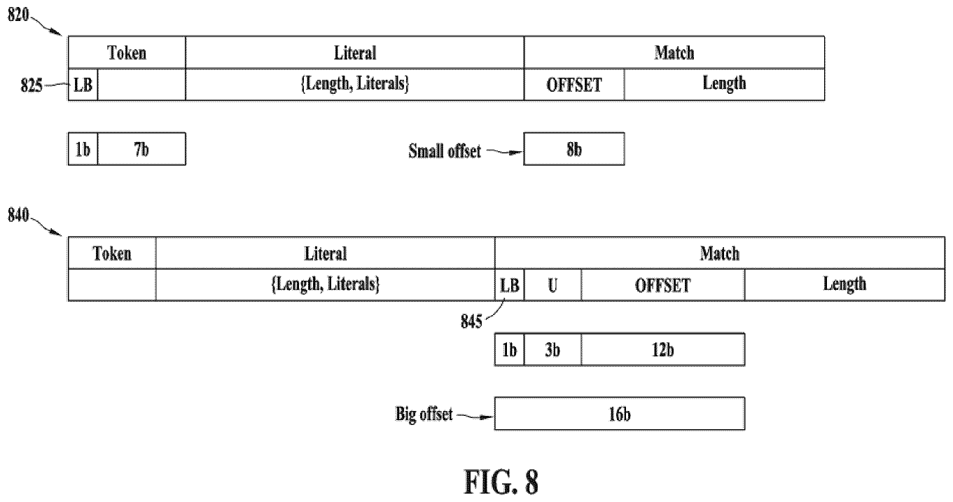

FIG. 8 illustrates a last compressed block, in accordance with an embodiment of the present disclosure.

Referring to FIG. 8, a last compressed block (e.g., block 340 described with reference to FIG. 3C) of the history-based (e.g., LZ4) compression technique may have a structure different from other blocks. In some cases, there may be no match information in the last compressed data block (e.g., TOKEN.M=0, and there may be no match offset byte). As shown in block 820 and block 840 of FIG. 8, the bytes following the token may refer either to length information (length bytes) or a mismatch string (e.g., literals). In some cases, scanning of the original string may be constrained to end with a mismatch string since there is no match information (e.g., the match offset byte is absent) in the last compressed block (e.g., block 340 of FIG. 3C).

In some cases, when the scanning ends with a match string of length p, the string may have to be forcefully split into two parts, for example, a first part with a match string of size p−1 and a second part with a mismatch string of size 1. In some cases, as shown in block 340 in FIG. 3C, a minimum size of the last compressed block may be 2 bytes (e.g., TOKEN.L=1, TOKEN.M=0, followed by 1 byte of the mismatch string). Accordingly, a minimum overhead of 2 bytes may be present from the last compressed block in case of an LZ4 compression technique, even when the scanning ends with a match string.

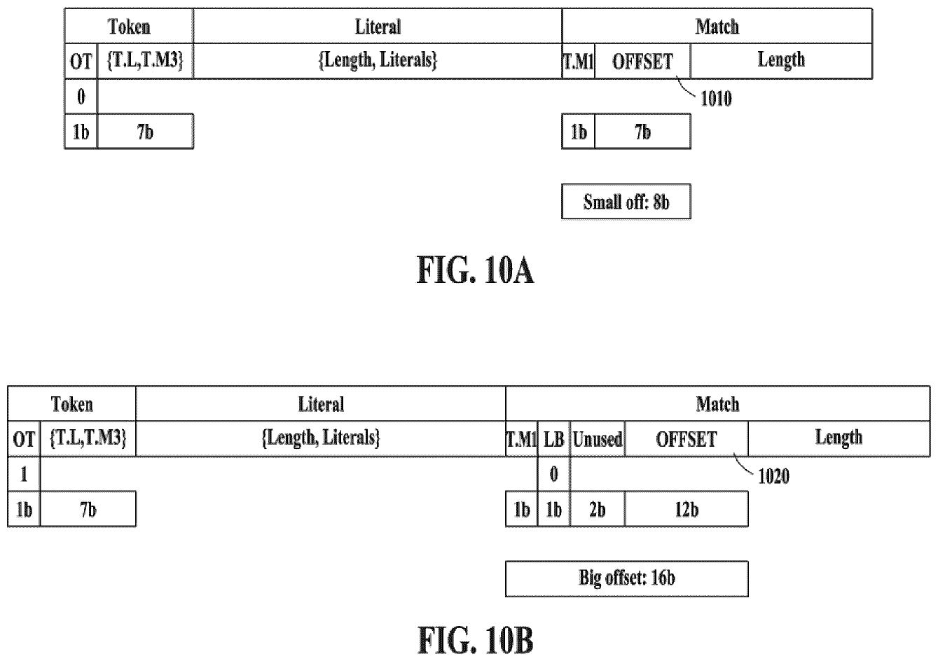

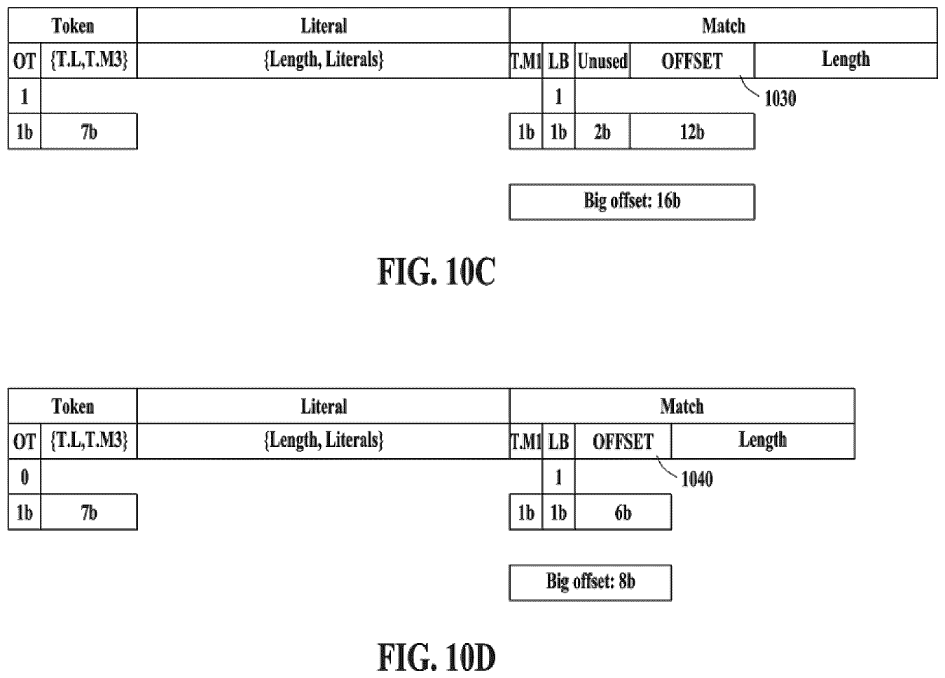

According to an embodiment of the present disclosure, the last compressed block (e.g., block 820 and block 840) may be identified using a last block (LB) flag (e.g., LB 825 and LB 845) in an unused bit of the compressed block (e.g., as shown with reference to FIG. 8). As shown in FIG. 8, LB 825 may be a part of the token section of the compressed block to indicate block 820 as the last compressed block. According to an embodiment, LB 845 may be a part of the match section of the compressed block to indicate the block 840 as the last compressed block. FIG. 8 illustrates an example of the position of the LB flag in the last compressed block, and the LB flag may be positioned according to a plurality of configurations, as discussed with reference to FIGS. 10A to 13B.

Hence, when the last compressed block ends with a match string rather than a mismatch string, the last compressed block may be denoted using only a flag, thereby reducing the overhead by 2 bytes. Additionally, the matched string may not be forcefully split to indicate the last compressed block. In some cases, the type of search operation may be indicated in one bit of a token field, for example, the TOKEN section, of each of the generated one or more compressed blocks (e.g., the one or more first and second compressed blocks), as is discussed in detail with reference to FIGS. 10A to 13B.

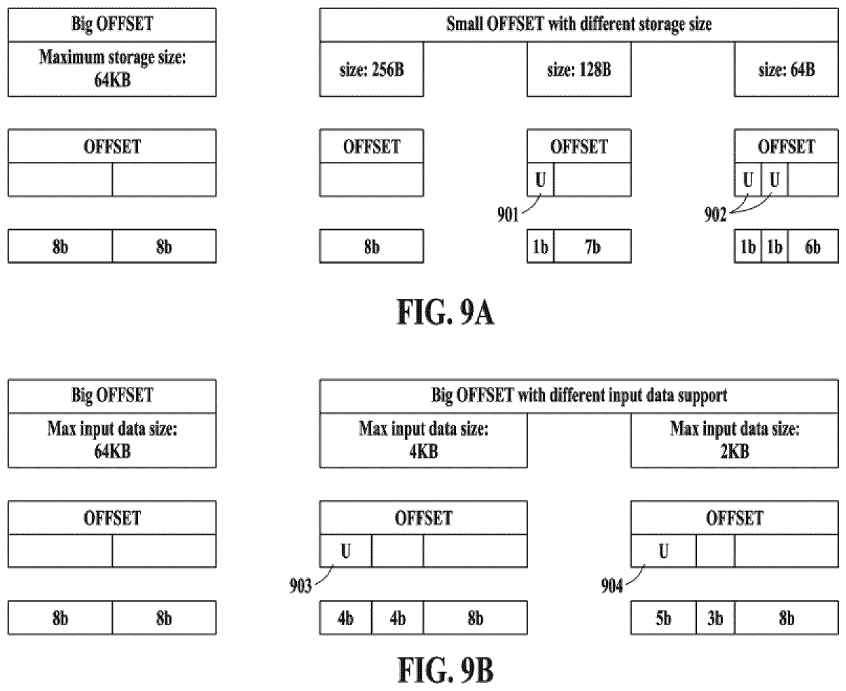

FIGS. 9A and 9B illustrate exemplary scenarios of determining an unused bit to indicate the last compressed block, in accordance with an embodiment of the present disclosure.

Referring to FIGS. 9A and 9B, a near buffer (e.g., near buffer 440 described in FIG. 4) may have a maximum size of 2\hat{ }8=256 bytes, using a small offset (e.g., 8 bits). In some cases, as shown in offset 1010 in FIG. 10A, the match offset may be represented using 7 or 6 bits, respectively, when the size of the near buffer 440 may be reduced from 256 bytes to 128 bytes or 64 bytes. As a result, 1 to 2 bits may be unused (e.g., unused bits 901, 902, 903, and 904, indicated as “U” in FIGS. 9A and 9B) in the near buffer 440, depending on whether the size of the near buffer 440 is 128 bytes or 64 bytes, respectively. Accordingly, at least one of the unused bits may be used to indicate the last compressed block. In some cases, when the near buffer 440 has a maximum size of 256 bytes, no bit may be left unused. According to an embodiment, a compressor (e.g., the compressor 430 of FIG. 4) may determine the size of the near buffer, i.e., the compressor determines whether to keep the size of the near buffer 440 as 256 bytes or less than (e.g., less than or equal to 128 bytes) 256 bytes.

According to an embodiment, the big offset may be used to determine an unused bit to indicate the last compressed block. An input data string may have a maximum size of 64 KB using the big offset of 16 bits (as shown in FIG. 10B). In some cases, when the maximum size of the input data string may be reduced, for example to 32 KB, at least one bit may remain as an unused (e.g., “U”) bit. Accordingly, when the maximum size of the input data string may be further reduced to 4 KB and 2 KB, 4 “U” bits and 5 “U” bits may be obtained, respectively. In some cases, at least one of the unused bits may be used to indicate the last compressed block. The allocation of the unused “U” bits is discussed with reference to FIGS. 10A to 13B.

According to an embodiment, the compressor 430 may determine whether to use (e.g., enable or disable) the far buffer 450. For example, when the system 400 consists of only the near buffer 440, then the processor(s) 420 may determine not to use the far buffer 450. According to an embodiment, the compressor 430 may evaluate whether to enable (e.g., access) the far buffer 450 even when the system 400 consists of the far buffer 450. Accordingly, the compressor 430 may compress the data input string according to one of the scenarios described in Table 1. Table 1 may depict possible configurations of the near buffer 440 and the far buffer 450, in accordance with an embodiment of the present disclosure:

TABLE 1

| Configuration id | DISABLE_FAR | IS_NEAR_BUFF_256B | Comment |
|---|---|---|---|
| 0 | 0 | 0 | Far buff enabled, Near |
| | | | buff size < 256 byte |
| 1 | 0 | 1 | Far buff enabled, Near |
| | | | buff size = 256 byte |
| 2 | 1 | 0 | Far buff disabled, |
| | | | Near buff size < 256 |
| | | | byte |
| 3 | 1 | 1 | Far buff disabled, |
| | | | Near buff size = 256 |
| | | | byte |

According to Table 1, IS_NEAR_BUFF_256B may represent whether the compressor 430 sets the size of the near buffer 440 to 256 bytes or less than 256 bytes (e.g., less than or equal to 128 bytes). For example, when IS_NEAR_BUFF_256B has a value of 0, the size of the near buffer 440 may be set to less than 256 bytes (e.g., less than or equal to 128 bytes). When IS_NEAR_BUFF_256B has a value of 1, the size of the near buffer 440 may be set to 256 bytes.

As shown in Table 1, DISABLE_FAR may represent whether the compressor 430 enables or disables the far buffer 450. For example, when DISABLE_FAR has a value of 0, the far buffer 450 may be enabled. Additionally, for example, when DISABLE_FAR has a value of 1, the far buffer 450 may be disabled or unavailable.

FIGS. 10A to 13B illustrate various exemplary scenarios of the enabled states of a near buffer and a far buffer, in accordance with an embodiment of the present disclosure.

FIGS. 10A to 10D may illustrate a case where DISABLE_FAR=0 and IS_NEAR_BUFF_256B=0.

In some cases, when DISABLE_FAR=0, a far buffer (e.g., the far buffer 450 of FIG. 4) may be in an enabled state. A compressor (e.g., compressor 430 of FIG. 4) may choose to use one of (e.g., one of the small offset or the big offset) the near buffer 440 or the far buffer 450 using an operation type (i.e., OT) flag. The OT flag may be used at a starting bit of any block. For example, the OT flag may be indicated in the top 7th bit (e.g., TOKEN [7]) of the TOKEN section. By allocating the OT flag as the starting bit of the block, the compressor 430 may determine the size of match offset (e.g., offsets 1010 to 1040) in advance. For example, the compressor 430 may determine the size of match offset to be 2 bytes or 1 byte according to the OT flag. The compressor 430 may determine the OT flag based on a match status (e.g., whether a match is found using the near search operation or the far search operation) during the processing of the one or more first or second blocks (except the last compressed data block). The type of search operation may be identified based on a value of the OT flag. For example, OT=0 may indicate the small offset, i.e., the near search operation. Additionally, for example, OT=1 may indicate the big offset, i.e., the far search operation.

In some cases, available space for the TOKEN section to store total length (T.L) and total match length (T.M) may be reduced from 8 bits to 7 bits since 1 bit is borrowed from the TOKEN section to indicate the OT flag. In some cases, the 4 bits of T.L followed by 3 bits of T.M (indicated as T.M3) may be kept in the compressed block since literal string or mismatch string may be encoded before the match string during block processing. In some cases, 1 bit may be allocated for T.M (indicated as T.M1). In some cases, at least 1 bit may be unused since IS_NEAR_BUFF_256B=0 and the size of the near buffer 440 is less than 256 bytes. As shown in FIG. 10A, T.M1 may be allocated in Small offset [7th bit] when the small offset is used. Hence, 4 bits of T.M may be formed by concatenating {T.M3, T.M1}. The remaining 7 bits, e.g., Small offset [6:0], may be used for match offset using the near buffer 440. In some cases, as shown in FIG. 10B, T.M1 may be allocated in Big offset [15th bit] when the big offset is used.

FIG. 10C shows a near match operation at the end (e.g., during last block generation). In some cases, the near search operation may be converted to the far search operation to have provision for more “U” bits due to unavailability of the unused “U” bit in the OFFSET field (as the “U” bit is already occupied by T.M1 as shown in FIG. 10A). As a result, the value of the OT flag may become 1 (e.g., using big offset of 2 bytes) to provide “U” bit in the offset field where “LB” flag may be accommodated. In some cases, T.M1 may be stored in Big offset [15th bit] since OT flag 1 may be used which signifies Big offset. Additionally, LB flag may be stored in Big offset [14th] bit among 3 unused “U” bits in offset field (e.g., Big offset [14:12]). Hence, 2 “U” bits may be left over after allocating T.M1 and LB flag.

During the last compressed block, the LB flag may be allocated in two ways based on the size of the near buffer 440. When the size of the near buffer (e.g., near buffer 440 in FIG. 4) is less than 128 bytes (e.g., IS_NEAR_BUFF_256B=0), the LB flag may be allocated to the 6th bit of small offset (e.g., Small offset [6th bit]=LB, as shown in FIG. 10D). Accordingly, the near search operation may not be converted into the far search operation. Hence, the LB flag may be accommodated inside Small offset [6th bit]. When the size of the near buffer 440 is greater than 128 bytes, there may be no “U” bit after allocating T.M1 (as shown in FIG. 10A). Hence, during the processing of the last compressed block, OT=1 (e.g., Big offset) utilizes “U” bits, e.g., Big offset [14th bit] may be assigned to the LB. Hence, the Big offset size may be used even when a match is found using the near search operation.

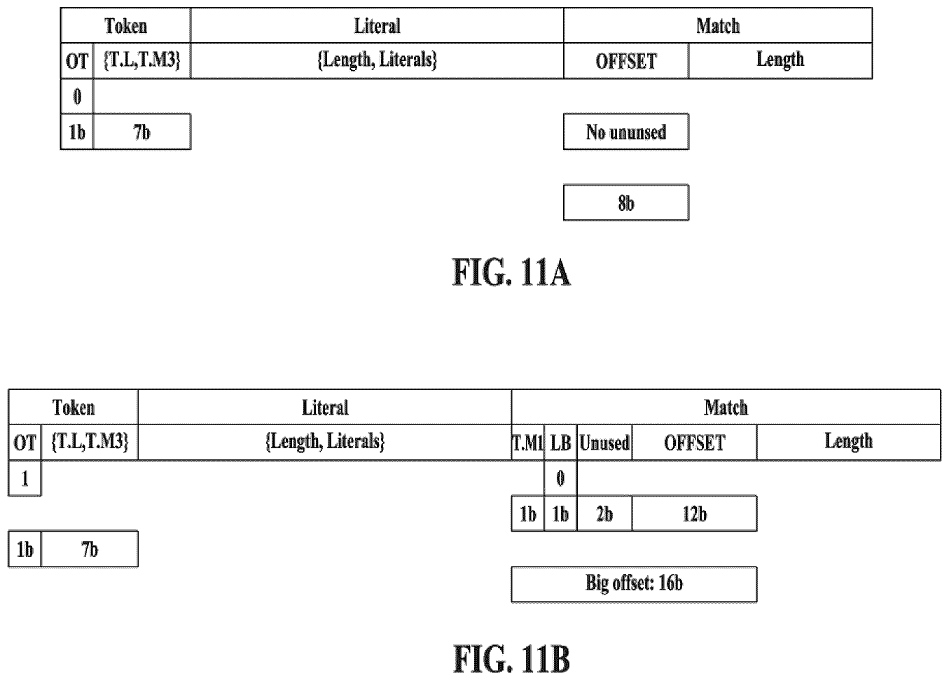

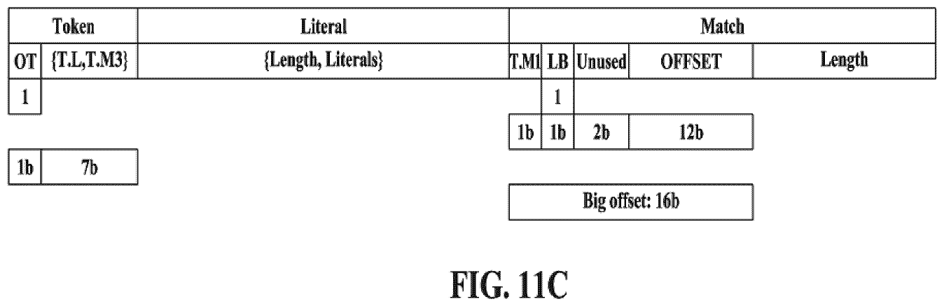

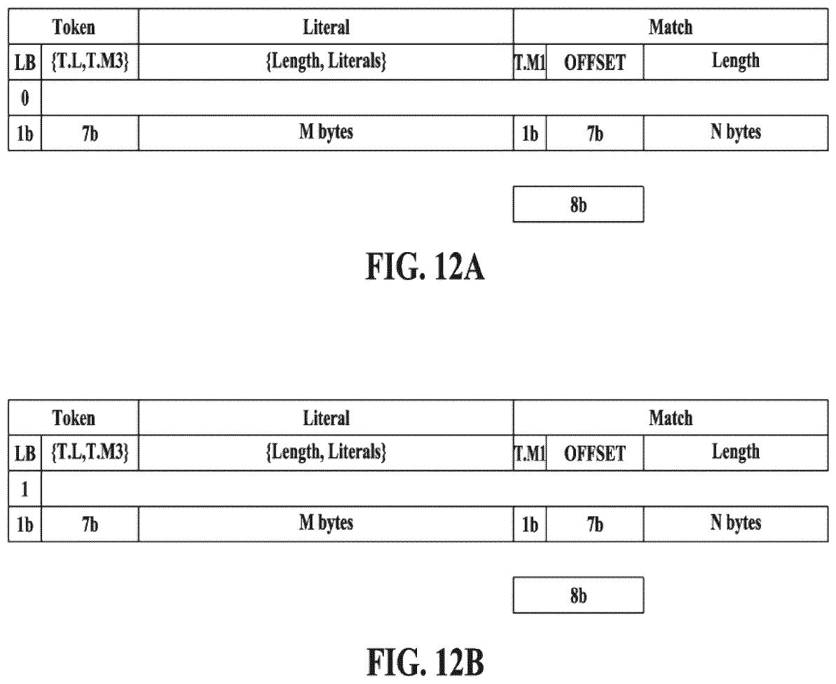

FIGS. 11A to 11C may illustrate a case where DISABLE_FAR=0 and IS_NEAR_BUFF_256B=1.

In some cases, the compressor 430 may choose to use one of a near buffer 440 or a far buffer 450 (compressor 430, near buffer 440, and far buffer 450 are described with reference to FIG. 4) (e.g., to use the small offset or the big offset) using an OT flag since the far buffer (e.g., the far buffer 450 of FIG. 4) is enabled (e.g., DISABLE_FAR=0). In some cases, the size of the near buffer 440 may be 256 bytes (e.g., IS_NEAR_BUFF_256B=1). Hence, the unused “U” bit may not be available for the small offset. Accordingly, T.M may be used as 3 bits instead of 4 bits while using the small offset after accommodating the OT flag. In some cases, T.M may be used as 4 bits for the big offset and T.M1 may be assigned to the Big offset [15th bits]. Further, the LB flag may be assigned using the Big offset [14th bit]. Regarding the last compressed data block, OT=1 (e.g., the Big offset used). In some cases, the LB flag may be marked as 1 (as shown in FIG. 11C). Hence, the Big offset may be used while generating the last compressed block even when the match is found using the near search operation.

FIGS. 12A and 12B may illustrate a case where DISABLE_FAR=1 and IS_NEAR_BUFF_256B=0.

Referring to FIG. 12A, a compressor (e.g., the compressor 430 of FIG. 4) may use only a near buffer (e.g., the near buffer 440 of FIG. 4). The OT flag indicating the offset type (1 byte or 2 bytes) may not be used because the compressor 430 consistently uses the near buffer 440. Hence, a 1 byte match offset may be used. In some cases, the size of the near buffer 440 may be less than 256 bytes (e.g., IS_NEAR_BUFF_256B=0). Hence, at least one unused “U” bit may be available. LB flag may be assigned as shown in FIGS. 12A and 12B. For example, the LB flag may be assigned by borrowing 1 bit from the Token section. Accordingly, 7 bits may be available to store T.L and T.M since 1 bit is borrowed from the Token section. Additionally, the literal string or mismatch string may be encoded before the match string, so the 4 bits may be assigned to T.L first and then the 3 bits may be assigned to T.M (indicated as T.M3). Additionally, one more bit for T.M (T.M1) may be assigned for small offset [7th bit]. Hence, 4 bits of T.M may be formed by concatenating {T.M3, T.M1}. Regarding the last compressed data block, the value of LB flag may be 1 (as shown in FIG. 12B).

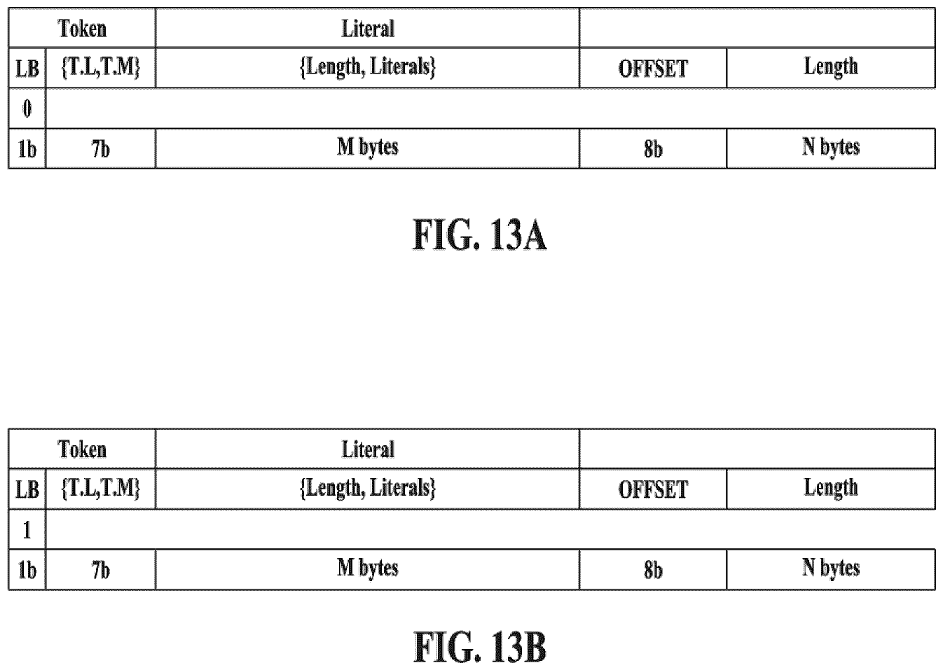

FIGS. 13A and 13B may illustrate a case where DISABLE_FAR=1 and IS_NEAR_BUFF_256B=1.

In some cases, since a far buffer (e.g., the far buffer 450 of FIG. 4) is disabled (e.g., DISABLE_FAR=1), a compressor (e.g., the compressor 430 of FIG. 4) may use a near buffer (e.g., the near buffer 440 of FIG. 4). The OT flag indicating the offset type (1 byte or 2 byte) may not be used because the compressor 430 may always use the near buffer 440. Therefore, 1 byte match offset may be used. Further, the size of the near buffer 440 may be 256 bytes (e.g., IS_NEAR_BUFF_256B=1), as a result, “U” bit may not be available. In some cases, the unused “U” bit may not be available. T.M may be used as 3 bits instead of 4 bits as the unused “U” bit is not available after borrowing LB flag from the Token section. Regarding the non-last compressed data block, LB may be set to 0. Regarding the last compressed data block, LB may be set to 1.

Accordingly, the present disclosure may provide various advantages. For example, embodiments of the present disclosure may provide methods for optimizing the history-based (e.g., LZ4) compression. Embodiments of the present disclosure may reduce the overhead associated with indicating the last compressed data block in the chain of compressed data blocks. Additionally, the present disclosure may provide systems and methods for reducing the size of the minimum data block of the compressed data. The disclosed techniques may improve the compression ratio.

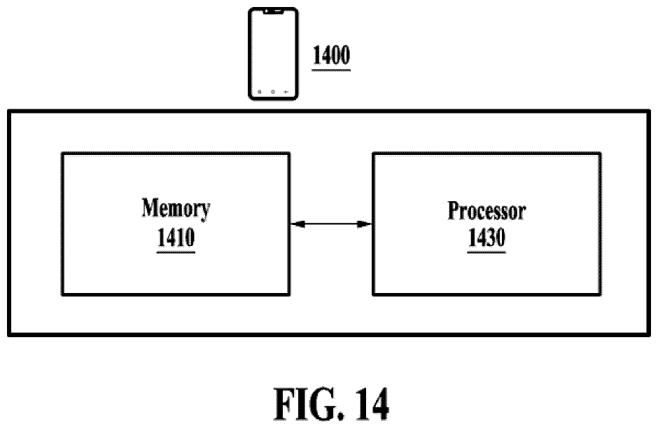

FIG. 14 illustrates an example of an electronic device, in accordance with an embodiment of the present disclosure.

An electronic device 1400, as shown in FIG. 14, may be a device for performing the compression method described with reference to FIGS. 4 to 13B. The electronic device 1400 may include a memory 1410 and a processor 1430. According to some aspects, electronic device 1400 is, but not limited to, a phone, personal computer, laptop computer, mainframe computer, palmtop computer, personal assistant, mobile device, or any other suitable processing apparatus.

The memory 1410 may store instructions (or programs) executable by the processor 1430. For example, the instructions may include instructions for executing an operation of the processor 1430 and/or an operation of each component of the processor 1430.

The memory 1410 may include one or more computer-readable storage media. The memory 1410 may include non-volatile storage devices such as magnetic hard discs, optical discs, floppy discs, flash memories, electrically programmable memories (EPROM), and electrically erasable and programmable memories (EEPROM), etc.

The memory 1410 may be non-transitory media. As used herein, the term “non-transitory” may indicate that the storage medium may not be implemented as a carrier wave or propagated signal. However, the term “non-transitory” should not be construed to mean that the memory 1410 is immovable.

The memory 1410 may store instructions for dividing a neural signal into a plurality of signal sections based on whether a spike signal is detected in the neural signal, determining a compression ratio corresponding to each of the plurality of signal sections, and compressing a signal portion included in each of the plurality of signal sections according to the compression ratio. However, this is merely an example, and information to be stored in the memory 1410 is not limited to the aforementioned example.

The processor 1430 may process data stored in the memory 1410. The processor 1430 may execute computer-readable code (e.g., software) stored in the memory 1410 and instructions triggered by the processor 1430.

The processor 1430 may be a data processing device implemented as hardware having a circuit with a physical structure for executing desired operations. For example, the desired operations may include code or instructions included in a program.

A hardware-implemented data processing device may include, for example, a microprocessor, a central processing unit, a processor core, a multi-core processor, a multiprocessor, an application-specific integrated circuit (ASIC), and a field programmable gate array (FPGA).

The processor 1430 may cause the electronic device 1400 to perform one or more operations by executing code and/or instructions stored in the memory 1410. The operations performed by the electronic device 1400 may be substantially identical to the compression method performed by the components of the system 400 described with reference to FIGS. 4 to 13B. Therefore, a repeated discussion related thereto is omitted.

The embodiments described herein may be implemented using hardware components, software components and/or combinations thereof. A processing device may be implemented using one or more general-purpose or special purpose computers, such as, for example, a processor, a controller and an arithmetic logic unit (ALU), a digital signal processor, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described hardware devices may be configured to act as one or more software modules in order to perform the operations of the above-described examples, or vice versa.

While this disclosure includes specific embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A data compression method comprising:
receiving a data input string comprising one or more segments;
performing a search operation on the data input string;
determining a type of the search operation, wherein the type of the search operation comprises a near search operation or a far search operation; and
generating one or more compressed data blocks corresponding to the one or more segments of the data input string based on the determined type of the search operation.

2. The method of claim 1, wherein the generating comprises:
in response to the type of the search operation being determined as the near search operation, including an indication of the near search operation in the one or more compressed data blocks.

3. The method of claim 2, wherein each of the one or more segments has a minimum size of 3 bytes and the one or more compressed data blocks has a minimum size of 2 bytes based on the type of the search operation comprising the near search operation.

4. The method of claim 1, wherein the generating comprises:
in response to the type of the search operation being determined as the far search operation, including an indication of the far search operation in the one or more compressed data blocks.

5. The method of claim 4, wherein each of the one or more segments has a minimum size of 4 bytes and the one or more compressed data blocks has a minimum size of 3 bytes based on the type of the search operation comprising the far search operation.

6. The method of claim 1, wherein the generating comprises:
indicating the determined type of the search operation in at least one bit of a token field of each of the one or more compressed data blocks.

7. The method of claim 1, wherein the generating comprises:
indicating a block among the one or more compressed data blocks as a last compressed block using an unused bit of the one or more compressed data blocks.

8. A non-transitory computer-readable storage medium storing instructions that, when executed by a processor, cause the processor to perform operations including:
receiving a data input string comprising one or more segments;
performing a search operation on the data input string;
determining a type of the search operation, wherein the type of the search operation comprises a near search operation or a far search operation; and
generating one or more compressed data blocks corresponding to the one or more segments of the data input string based on the determined type of the search operation.

9. The non-transitory computer readable medium of claim 8, wherein each of the one or more segments has a minimum size of 3 bytes and the one or more compressed data blocks has a minimum size of 2 bytes based on the type of the search operation comprising the near search operation.

10. The non-transitory computer readable medium of claim 8, wherein each of the one or more segments has a minimum size of 4 bytes and the one or more compressed data blocks has a minimum size of 3 bytes based on the type of the search operation comprising the far search operation.

11. The non-transitory computer readable medium of claim 8, wherein the generating comprises:
indicating the determined type of the search operation in at least one bit of a token field of each of the one or more compressed data blocks.

12. The non-transitory computer readable medium of claim 8, wherein the generating comprises:
indicating a block among the one or more compressed data blocks as a last compressed block using an unused bit of the one or more compressed data blocks.

13. An electronic device comprising:
one or more processors; and
a memory configured to store instructions,
wherein the instructions, when executed by the one or more processors, cause the apparatus to:
receive a data input string comprising one or more segments;
perform a search operation on the data input string;
determine a type of the search operation, wherein the type of the search operation comprises a near search operation or a far search operation; and
generate one or more compressed data blocks corresponding to the one or more segments of the data input string based on the determined type of the search operation.

14. The device of claim 13, wherein the instructions, when executed by the one or more processors, cause the device to:
in response to the type of search operation being determined as the near search operation, include an indication of the near search operation in the one or more compressed data blocks.

15. The device of claim 14, wherein each of the one or more segments has a minimum size of 3 bytes and each of the one or more compressed data blocks has a minimum size of 2 bytes based on the type of the search operation comprising the near search operation.

16. The device of claim 13, wherein the instructions, when executed by the one or more processors, cause the device to:
in response to the type of search operation being determined as the far search operation, include an indication of the far search operation in the one or more compressed data blocks.

17. The device of claim 16, wherein each of the one or more segments has a minimum size of 4 bytes and the one or more compressed data blocks has a minimum size of 3 bytes based on the type of the search operation comprising the far search operation.

18. The device of claim 13, wherein the instructions, when executed by the one or more processors, cause the device to:
indicate the determined type of the search operation in at least one bit of a token field of each of the one or more compressed data blocks.

19. The device of claim 13, wherein the instructions, when executed by the one or more processors, cause the device to:
indicate a block among the one or more compressed data blocks as a last compressed block using an unused bit of the one or more compressed data blocks.
